(19) United States
(12) Patent Application Publication
(10) Pub. No.: US 2003/0055902 A1
(43) Pub. Date: Mar. 20, 2003

(54) Systems and methods for remotely updating e-mail message status information for messages forwarded from a host system e-mail account across a firewall to a wireless handheld device

(76) Inventors: Elan Amir, San Francisco, CA (US); John Hanay, Palo Alto, CA (US)

Correspondence Address: FISH & NEAVE, 1251 AVENUE OF THE AMERICAS, 50TH FLOOR, NEW YORK, NY, 10020-1105, US

(21) Appl. No.: 09/952,460

(22) Filed: Sep. 14, 2001

(51) Int. Cl. G06F 15/16

(52) U.S. Cl. 709/206

(57) ABSTRACT

Systems and methods for remotely updating e-mail message status information for messages forwarded from a desktop e-mail account to a wireless handheld device are provided. The systems and methods of the present invention consist of a software solution that enables users of wireless handheld appliances to: access corporate e-mail by forwarding incoming e-mail messages from the user's corporate account to the handheld appliance; act upon the received e-mail messages at the handheld appliance; and to have the system update the status of the acted upon messages at the user's corporate e-mail account.

### FIELD OF THE INVENTION

This invention relates generally to systems and methods for using a wireless handheld appliance to remotely access and manage e-mail messages received at a host system. More specifically, the present invention provides systems and methods for updating the status information of e-mail messages received at a corporate e-mail account associated with a host system, which messages have been forwarded to, and subsequently read, deleted, or otherwise edited at a wireless handheld appliance across a corporate firewall. (In this application, references to “corporate e-mail” or “corporate firewall” encompass accounts maintained by any user or organization).

### BACKGROUND OF THE INVENTION

The Internet and the World Wide Web (hereinafter “the web”) have revolutionized the ways in which information is disseminated and shared. At any given time, the Internet enables millions of users worldwide to communicate, access a wide variety of information, and engage in activities as diverse as shopping, playing games, and financial trading, among others.

The vast array of services provided in the Internet has driven users, including business professionals, to demand Internet access from anywhere in the world. As a result, a new set of networking technologies has been developed. In particular, the emergence of wireless networks has led to development of various access technologies for handheld appliances such as wireless telephones, two-way pagers, and personal digital assistants (“PDAs”).

Mobile users connected to a wireless network can access the Internet on a wireless appliance from any location covered by the network. Wireless networks include personal area networks (“WPANs”) based on the Bluetooth™ standard, wireless local area networks (“WLANs”) based on the Institute of Electrical and Electronics Engineers (“IEEE”) 802.11 standards, and wireless wide area networks (“WWANs”) based on open wireless standards such as AMPS, GSM, TDMA, CDMA, and CDPD. Both WPANs and WLANs offer limited user mobility, while WWANs allow users to roam freely across extensive geographic areas.

At present, most mobile users access the Internet through a WWAN by using a wireless appliance equipped with a wireless modem and Internet access software. The wireless modem may be either internally integrated into the Internet appliance, such as in the case of the Palm VIIx PDA, manufactured by Palm, Inc., of Santa Clara, Calif., or connected externally. External wireless modems include the various modems manufactured by Novatel Wireless, Inc., of San Diego, Calif., and Sierra Wireless, Inc., of Richmond, BC, for use with PDAs and cellular phones across WWANs operated by a wireless carrier, such as Sprint PCS, of Overland Park, Kans., Verizon Wireless, of New York City, N.Y., and AT&T wireless, of Seattle, Wash.

To access Internet content on a WWAN, users are required to subscribe to a wireless service plan offered by a wireless service provider. A wireless service provider is a company that offers cellular phone service and/or wireless Internet service including e-mail and web access through a WWAN. Examples of wireless service providers offering Internet access include Verizon Wireless, Metricom, Inc., Sprint PCS, and OmniSky Corporation, of San Francisco, Calif. The wireless service plans are provided on a monthly or annual fee basis, with the fee depending on the type of services and geographic coverage desired.

Of the wireless devices capable of accessing Internet content, it has become increasingly popular for business professionals to access information via PDAs, such as the Palm handheld devices manufactured by Palm, Inc., of Santa Clara, Calif., the Handspring Visor manufactured by Handspring, Inc., of Mountain View, Calif., and the HP Jornada manufactured by the Hewlett-Packard Company of Palo Alto, Calif. A PDA provides computing and information storage and retrieval capabilities for personal or business use, often for keeping schedule calendars and address book information handy. The PDA is extremely mobile and can be utilized by business persons and consumers who are traveling or otherwise do not have access to a desktop computer. The PDA enables business persons and consumers to manage, share, and secure the information needed on a daily basis. Importantly, a PDA user can, via the Internet, remotely access Internet Service Provider (ISP) e-mail accounts. Such ISP e-mail accounts are typically accessed by the PDA pursuant to the Post Office Protocol 3 (“POP3”) standard or the Internet Message Access Protocol 4 (“IMAP”) standard, as set forth in Internet Request for Comments (“RFC”) No.'s 1939 and 2060, respectively, and related RFCs. This ability to access ISP e-mail accounts remotely has played an important role in enhancing the productivity of mobile business professionals.

However, until recently, mobile business professionals have been unable to remotely access corporate e-mail accounts using wireless handheld appliances. Typically, a business professional's corporate e-mail account is located on a desktop computer that is connected to a Local Area Network (LAN). Such corporate LANs are almost always protected from network intrusion by a “firewall” system. A firewall is a specific piece of hardware and/or software that bridges the connection between the LAN and the Internet. By preventing access to the corporate LAN from the Internet, the operation of the corporate firewall presents users with a barrier to accessing their corporate e-mail accounts wirelessly.

In response to this barrier, systems have been developed that allow remote access to corporate e-mail by forwarding incoming e-mail messages from the corporate account to an e-mail account accessible by the wireless handheld user. For example, U.S. Pat. No. 6,219,694 B1, assigned to Research in Motion, Ltd., of Waterloo, Calif., discloses a system for remotely accessing corporate e-mail the uses a redirector component installed on a system inside the firewall to continually push incoming e-mail messages from a host computer associated with a corporate e-mail account to a handheld device, such as a two-way pager, via a wireless server. Other systems that provide access to corporate e-mail accounts include Weblink Remote E-Mail Manager, designed by Weblink Wireless, Inc. of Dallas, Tex.

However, these systems do not provide for seamless integration between the corporate and wireless e-mail accounts. For example, in current systems, forwarded e-mails that are read or deleted on the wireless handheld device are not immediately marked as read or deleted in the corporate e-mail account. Thus, once the wireless handheld user accesses the corporate e-mail account using their desktop computer, the user must either scroll through the messages stored in the user's mailbox to determine which messages have already been acted upon by the user at the handheld appliance, or execute an additional “synchronization” operation to consolidate the changes.

In view of the foregoing drawbacks, it would be desirable to provide systems and methods for seamlessly integrating corporate e-mail accounts with wireless handheld e-mail services.

It further would be desirable to provide systems and methods for “real-time” updating of the status information of e-mail messages on a host system that have been forwarded to, and subsequently read, deleted, or otherwise edited at a wireless handheld device.

### SUMMARY OF THE INVENTION

In view of the foregoing, it is an object of the present invention to provide systems and methods for seamlessly integrating corporate e-mail accounts with wireless handheld e-mail services.

It is another object of the present invention to provide systems and methods for updating the status information of e-mail messages on a host system that have been forwarded to, and subsequently read, deleted, or otherwise edited at a wireless handheld device.

These and other objects of the present invention are accomplished by providing systems and methods for seamlessly integrating corporate e-mail accounts with wireless handheld e-mail services. The systems and methods consist of a software solution that enables users of wireless handheld appliances to: access corporate e-mail by forwarding incoming e-mail messages from the user's corporate account to the handheld appliance; act upon the received e-mail messages at the handheld appliance; and to have the system update the status of the acted upon messages at the user's corporate e-mail account.

In a preferred embodiment, the systems and methods of the present invention involve four main software components: (1) a host system e-mail client; (2) a forwarding mail agent that interacts with the host system e-mail client; (3) a remote access server component; and (4) a remote access e-mail client on the handheld appliance.

The host system e-mail client is any program that allows a user to send, receive, and otherwise manipulate e-mail messages on a host system. Examples of such desktop e-mail programs include Outlook 2000, developed by Microsoft Corp., of Redmond, Wash., Lotus Notes, developed by Lotus Development Corp., of Cambridge, Mass., and Eudora, developed by Qualcomm Corp., of San Diego, Calif.

The forwarding mail agent is installed on the user's host system, and integrates with the host system e-mail client to forward messages received at the e-mail account associated with the host system to an e-mail account accessible by the handheld appliance. Alternatively, the forwarding mail agent can be located on a corporate network server connected to the host system via the LAN behind the firewall.

In the preferred embodiment, the forwarding mail agent leverages the host system e-mail client's default transport mechanism to ensure the greatest likelihood that redirected messages can successfully pass through the corporate firewall. It is also preferred that the forwarding mail agent supports filtering mechanisms built into the host system e-mail client to allow the user to selectively forward e-mails to the handheld appliance. Such filtering mechanisms determine which e-mails are sent by the desktop e-mail program based on such considerations as size, type of attachments, recipient, etc.

The remote access server component is a software component located outside the firewall on a mail proxy server associated with a separate e-mail account dedicated to remote access of the corporate e-mail account, i.e. the e-mail account located behind the firewall. In a preferred embodiment of the present invention, the forwarding mail agent forwards the incoming e-mail messages to the remote access server component, where the forwarded messages are stored until downloaded by the user to the handheld appliance.

The remote access e-mail client located on the handheld appliance allows the user to access and manage e-mail from at least one ISP account via a WWAN. The user can then read, delete, and/or reply to incoming e-mail messages with the remote access e-mail client, whether the incoming e-mail messages are (1) forwarded to a personal ISP account accessible by the remote access e-mail client, or (2) are forwarded to a separate ISP account accessible by the remote access e-mail client that is dedicated solely to remote access to the corporate e-mail account.

Further, changes in status for e-mails processed at the remote access e-mail client cause updated status information for e-mails processed at the handheld appliance to be forwarded to the e-mail forwarding mail agent. The e-mail forwarding mail agent then updates the messages stored on the host system e-mail client to reflect the updated status information.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic view of the system and the network environment in which the present invention operates;

FIG. 2 is a schematic view of the software components of the present invention;

FIG. 3A is a more detailed schematic view of the system of the present invention illustrating the process by which e-mails are forwarded from the host system to the handheld appliance;

FIG. 3B is a more detailed schematic view of the system of the present invention illustrating the process by which e-mails are sent from the handheld appliance; and

FIG. 3C is a more detailed schematic view of the present invention illustrating how e-mail status information at the host system e-mail client is updated in response to changes in status at the handheld appliance.

### DETAILED DESCRIPTION OF THE INVENTION

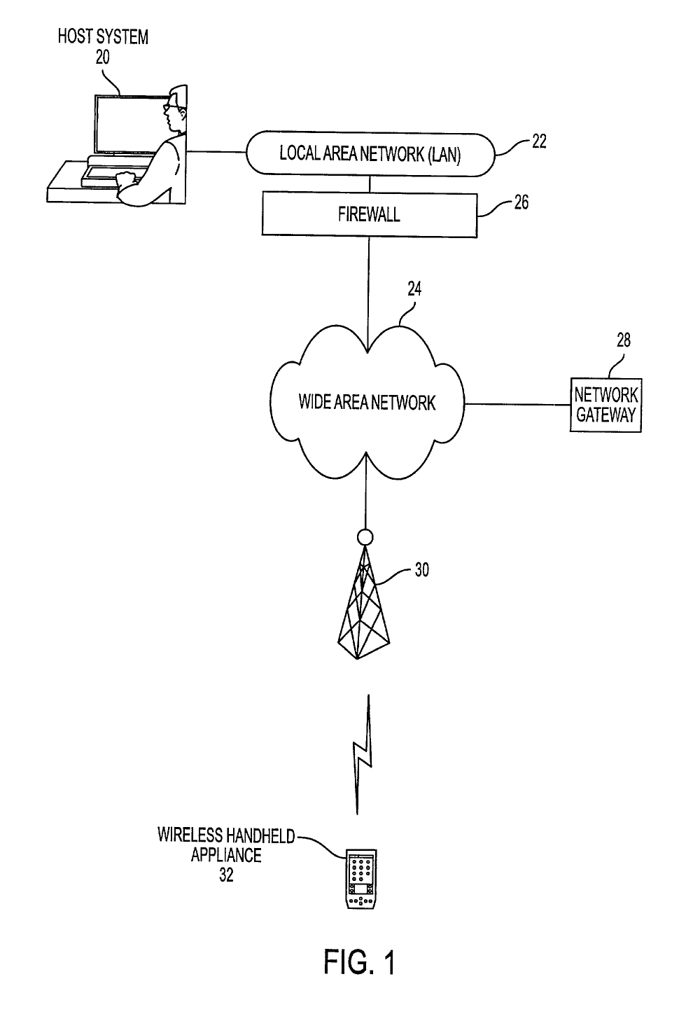

Referring to FIG. 1, a schematic view of the system and the network environment in which the present invention operates is described. Host system 20 is connected to LAN 22. Host system 20 is typically the user's corporate desktop computer, but alternatively can be any device that allows the user to access the corporate e-mail account and is protected by a firewall, including a laptop computer, a dummy terminal, or a wireless appliance. LAN 22 is connected to Wide Area Network (WAN) 24 through firewall 26. Preferably WAN 24 is the Internet, but alternatively WAN 24 can be any form of wide area network. WAN 24 is connected to various gateways 28, which form a connection between WAN 24 and other types of networks. In particular, WAN 24 is connected to a wireless wide area network represented by base station 30 for communicating with handheld appliance 32.

Handheld appliance 32 uses a wireless modem to connect to the Wireless Wide Area Network (“WWAN”) represented by base station 30. The wireless modem may be internally integrated into handheld appliance 32 such as in the case of the Palm VIIx, manufactured by Palm, Inc., or connected externally as an expansion module. External wireless modems include the Thinmodem manufactured by Card Access, Inc., of American Fork, Utah, and the various modems manufactured by Novatel Wireless Inc., of San Diego, Calif.

Handheld appliance 32 may consist of a personal digital assistant (PDA) such as the Palm handheld devices manufactured by Palm, Inc., of Santa Clara, Calif., the Handspring Visor manufactured by Handspring, Inc., of Mountain View, Calif., and the HP Jornada manufactured by the Hewlett-Packard Company of Palo Alto, Calif. Handheld appliance 32 may also consist of appliances having the functions of a PDA and a cellular phone, such as the PDA Phone manufactured by Samsung Electronics, Co., Ltd., of Seoul, South Korea, and the Kyocera QCP 6035 Smartphone manufactured by Kyocera Wireless Corp., of San Diego, Calif., or may also consist of a two way-pager.

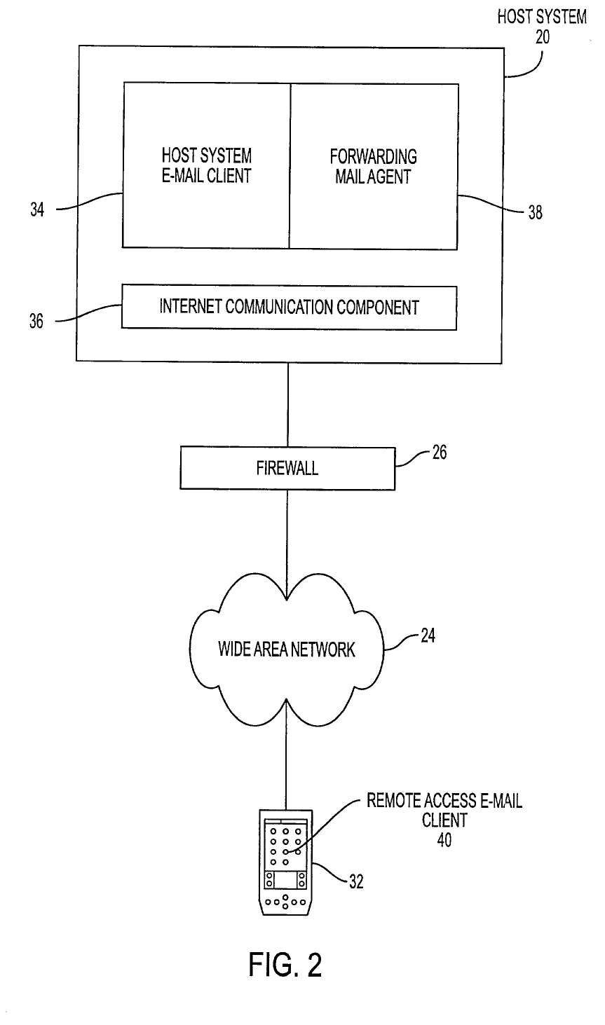

Referring to FIG. 2, a schematic view of the software components of the present invention is described. Host system 20, in addition to the hardware and software needed to operate the system, includes host system e-mail client 34, an Internet communication component 36, and forwarding mail agent 38. Alternatively, forwarding mail agent 38 can be located on a corporate network server connected to the host system via a LAN.

Host system e-mail client 34 is any software component that allows the user to send and receive e-mail messages over a network. Examples of such e-mail clients include Outlook 2000, developed by Microsoft Corp., of Redmond, Wash., Lotus Notes, developed by Lotus Development Corp., of Cambridge, Mass., and Eudora, developed by Qualcomm Corp., of San Diego, Calif. Typically, host system e-mail client 38 manages e-mail messages by storing them in appropriate directories, and by providing status information for all messages sent from or received at host system 20. In the preferred embodiment, directories for storing e-mail messages include “Inbox” for incoming messages, “Outbox” for outgoing messages, and “Deleted Items” for e-mail messages deleted by the user. Other directory structures can be set up by the user.

Status information for e-mail messages includes information regarding whether the e-mail has been read, forwarded, replied to, or deleted. In the preferred embodiment, this status information is recorded by status flags, such that the user can visibly determine the status of the message.

Internet communication component 36 is usually a Transmission Control Protocol/Internet Protocol (TCP/IP) component which provides the host system with a means for passing information to and from WAN 24 across a data connection, such as a T1 line, a cable modem, or a DSL line. Internet communication component 36 can be located on the host system, or on a server connected to the host system via the LAN.

Forwarding mail agent 38 is a software component installed on the host system that forwards a copy of incoming e-mail messages received at host system e-mail client 34 to handheld appliance 32. In the preferred embodiment, forwarding mail agent 38 is a dynamically linked library program (“DLL”) that leverages host system e-mail client 34. Forwarding mail agent 38 then uses host system e-mail client 34's default transport mechanism to ensure the greatest likelihood that the message forwarded via forwarding mail agent 38 can successfully pass through corporate firewall 26. This integration is represented by the overlapping area between host system e-mail client 34 and forwarding mail agent 38 in FIG. 2.

Forwarding mail agent 38 also allows the user to apply filtering rules to the messages to be forwarded to handheld appliance 32. Preferably, forwarding mail agent 38 supports the filtering mechanisms built into host system e-mail client 34 to allow the user to selectively forward e-mails to handheld appliance 32. For example, Outlook 2000, developed by Microsoft Corp., of Redmond, Wash., includes a filtering mechanism called Microsoft Outlook Filter Wizard, that allows the user to filter based on message sender, size of message, subject of message, etc. Alternatively, forwarding mail agent 38 can include its own filtering mechanism to determine which messages should be forwarded to handheld appliance 32.

Remote e-mail access client 40 located on handheld appliance 32 is a software component that allows the user to access and manage e-mail from one or more e-mail accounts via WWAN. The user, upon opening remote access e-mail client 40, selects which account associated with e-mail management program 40 to view. The user can read, delete, and/or reply to incoming e-mail messages from any one of the associated accounts.

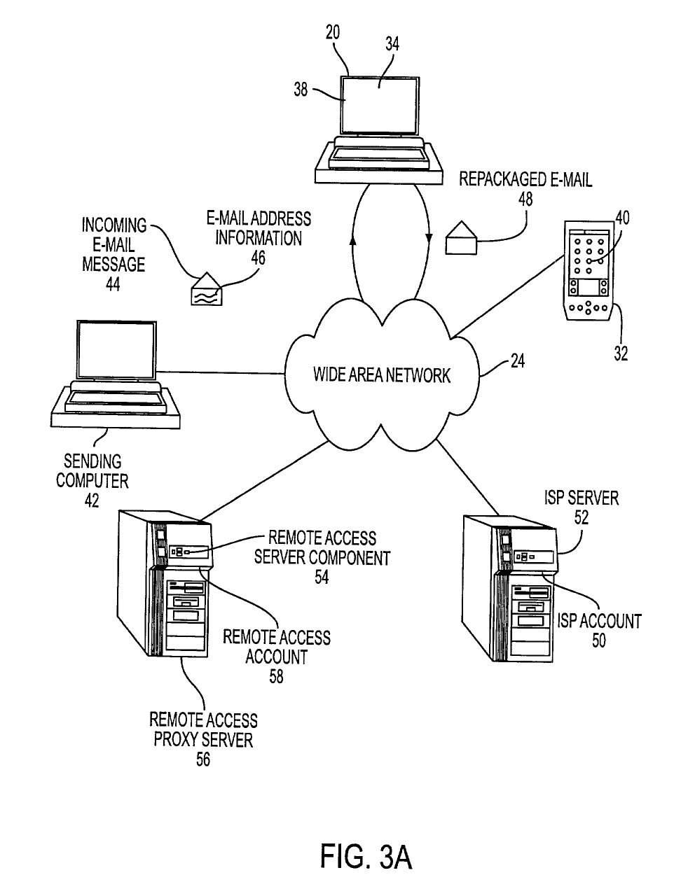

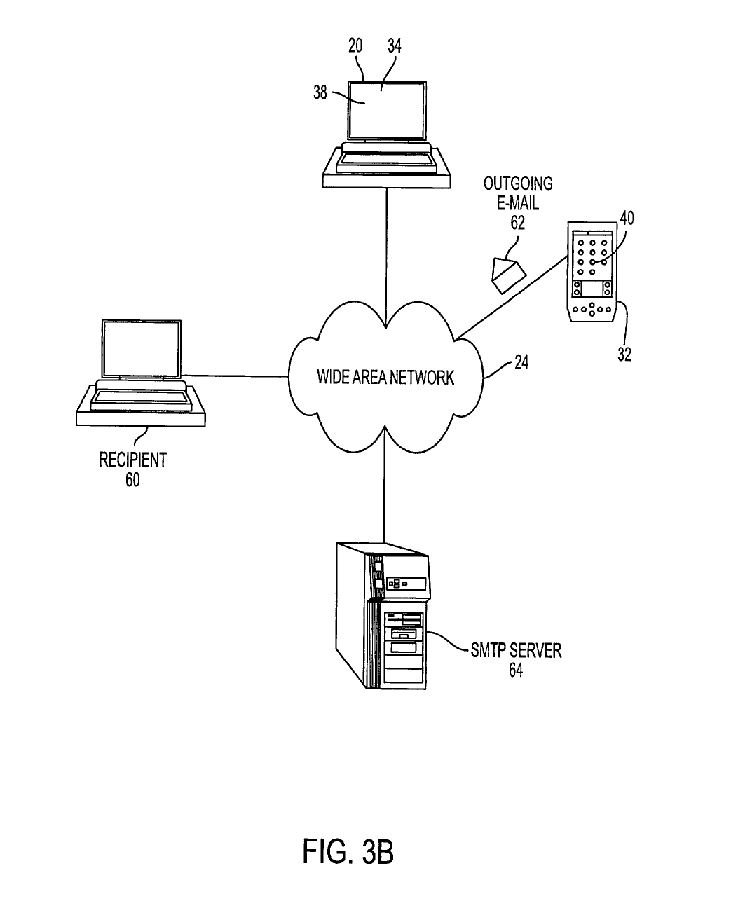

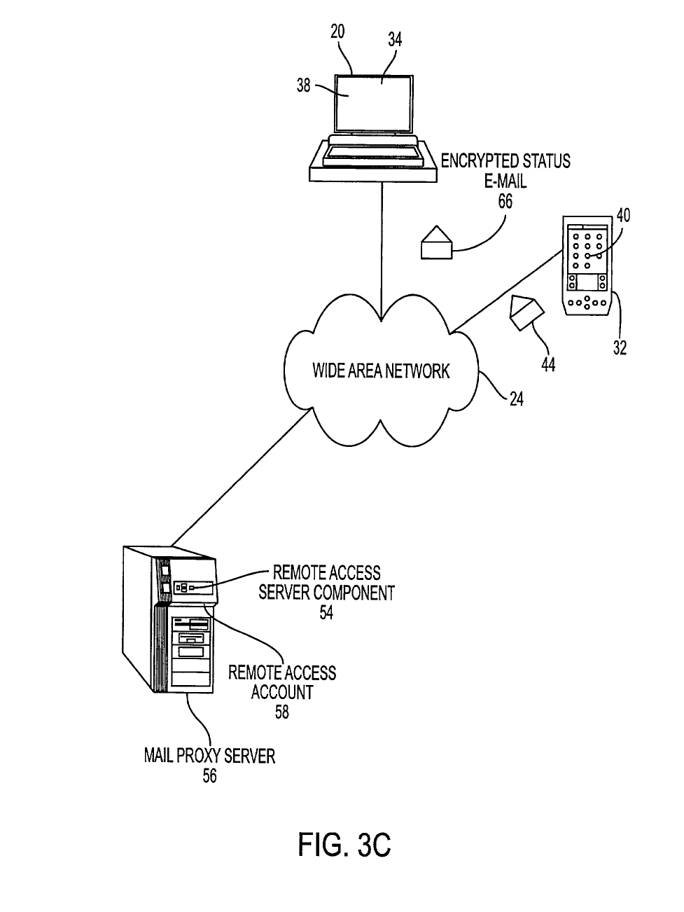

Referring to FIG. 3A, a schematic view of the process by which messages are sent to handheld appliance 32 is described. Sending computer 42 is any computer system that is capable of sending e-mail messages over a network. Sending computer 42 sends an e-mail message 44 with destination address 46. Destination address 46 specifies the destination as the network address of user's host system 20.

E-mail message 46 is received at host system e-mail client 34 on host system 20. Forwarding mail agent 38 on host system 20 then detects the arrival of e-mail message 44.

In the preferred embodiment, forwarding mail agent 38 uses the host system e-mail client 34's default message application program interface (“MAPI”) client extension to identify the arrival of a new message. In the case of Outlook 2000 this MAPI client extension is “On Delivery Event.” At this point, forwarding mail agent 38 determines whether it has been set to forward e-mail messages from host system 20 to handheld appliance 32. The user can either manually set forwarding mail agent 38 to forward incoming e-mail messages to handheld appliance 32, or alternatively, can program a set of “triggering events” to cause forwarding mail agent 38 to forward e-mails to the handheld appliance. Such triggering events could include an alarm from a calendar program on host system 20, activation of a screen saver on host system 20, or other event monitored by host system 20.

Next, forwarding mail agent 38 determines whether, based on the filtering rules in place, whether incoming e-mail message 44 should be forwarded to handheld appliance 32. If the e-mail message meets the filtering criteria, forwarding mail agent 38 prepares incoming e-mail message 44 to be forwarded to handheld appliance 32.

In a preferred embodiment, forwarding mail agent 38 repackages incoming e-mail 44 to be forwarded to handheld appliance 32 as repackaged e-mail 48, such that when repackaged e-mail 48 is opened by the user at handheld appliance 32, and the repackaging stripped off by remote access e-mail client 40, the address information of the original message sender is maintained. This ensures that any reply messages to the incoming e-mail 44 generated at handheld appliance 32 are directed to sending computer 42. Further, forwarding mail agent 38 encrypts the e-mail message to be forwarded using standard encryption methods, such as Triple DES encryption as set forth in Federal Information Processing Standard 46-3.

The present invention contemplates several methods by which forwarding mail agent 38 actually forwards incoming e-mail message 44 to handheld appliance 32. In a first method, the user sets forwarding e-mail agent 38 to forward incoming e-mail messages to a generic, personal ISP account 50 on ISP server 52, that the user can access via remote access e-mail client 40 on handheld appliance 32. The user then accesses remote access e-mail client 40, and selects the personal ISP account to which the user had programmed forwarding mail agent 40 to forward incoming e-mails. The user can then process the e-mails in the personal ISP account, including the forwarded e-mails. However, this first method has the disadvantage of mixing the user's corporate e-mail with the personal e-mail in the generic ISP account.

In a second method, forwarding mail agent 38 forwards a copy of e-mail message via WAN 24 to remote access server component 54 located on remote access proxy server 56. Remote access server component 54 stores repackaged e-mail message 48 in a remote access account 58 dedicated to remote access to the e-mails received at host system 20. Remote access server component 54 further maintains a table with both message identification and status information for all incoming e-mail messages received at remote access server 56. Remote access server 56 is a proxy server, preferably compatible with either the POP3 or IMAP standards in order to allow remote access e-mail client 40 to easily download messages stored on remote access server 56 to handheld appliance 32. The repackaged e-mail messages are stored in remote access account 58 on remote access server 56 until retrieved by the handheld user via a command from handheld appliance 32.

In order to access the forwarded message, the user accesses remote access e-mail client 40, and selects remote access account 58. In response to the user's command, repackaged e-mail 48 is downloaded to remote access e-mail client 40 at handheld appliance 32. Remote access e-mail client 40 then strips the repackaging and encryption from repackaged e-mail message 48, allowing the user to read, delete or otherwise process incoming e-mail message 44.

In FIG. 3B, a detailed schematic of the process by which e-mails are sent from the handheld appliance 32 to a recipient 60 is described.

Outgoing e-mail message 62 is generated on handheld appliance 32 using remote access e-mail client 40. Outgoing e-mail message 62 can either be a new message, a forwarded message, or a reply message. Outgoing e-mail message 62 is then uploaded by remote access e-mail client 40 to a server associated with handheld appliance 32 that is capable of sending e-mail messages via WAN 24. In the preferred embodiment, e-mail message 62 is uploaded to an SMTP server 64 associated with the user's handheld appliance 32 that is compatible with the Simple Mail Transfer Protocol (“SMTP”) standard, and then sent via WAN 24 to recipient computer 60.

FIG. 3C contains an illustration of the process by which status information for e-mails forwarded from the host system to the handheld appliance is updated. As described in connection with FIG. 3A, incoming e-mail message 44 is read, deleted, or forwarded by the user at handheld appliance 32 using remote access e-mail client 40. This causes the status information of e-mail message 44 to be updated on handheld appliance 32.

The present invention contemplates several methods by which e-mail status information on host system 20 for e-mails forwarded to handheld appliance 32 can be updated. In one embodiment, e-mail message identification and status information is maintained on mail proxy server 56. Upon repackaged e-mail message 48 being forwarded to handheld appliance 32, status information of the forwarded message can be updated by remote access server component 54 to indicate that forwarded incoming message 44 has been read by the user.

Alternatively, any changes in message status, including read, delete, forward, or reply, could be forwarded by remote access e-mail client 40 to remote access server component 54. Remote access server component 54 would then update the status information contained in the message table for the particular forwarded message. Remote access server component 54 then generates an encrypted status e-mail 62, which is sent to host system 20. Encrypted status e-mail 62 contains information regarding the identification of the forwarded message, and the change in status of the forwarded message. Preferably, the identification information is the same identification used by host system e-mail client 34 to identify incoming e-mail message 44 on host system 20.

Encrypted status e-mail 62 is received by host system e-mail client 34. Encrypted status e-mail 62 contains some command indication to trigger forwarding mail agent 38 to update the status information of e-mail message 44 forwarded to handheld appliance 32. In the preferred embodiment, the indication to trigger updating of the message status is the subject line being set to one that is recognized by forwarding e-mail agent 38 as a status update e-mail.

Forwarding mail agent 38 uses the host system e-mail client 34's default MAPI client extension to identify that a new message has arrived. Forwarding mail agent 38 then checks the subject heading to determine if the message is an update e-mail status message. If so, forwarding mail agent 38 decrypts the message, and uses the message identification and status information contained therein to locate and update the status information of incoming message 44 on host system e-mail client 32.

In a second embodiment, the message identification and status information is maintained on remote e-mail client 40. In this embodiment, remote e-mail client 40 (as opposed to remote access server component 54) generates the update status information message sent to forwarding mail agent 38 in accordance with the description above.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for updating e-mail status information of an e-mail received at an e-mail account associated with a host system on a local area network separated from a wireless wide area network by a firewall, the method comprising:
receiving an incoming e-mail message at the e-mail account associated with the host system;
forwarding a copy of the incoming e-mail message to a handheld appliance via the wireless wide area network;
processing the forwarded copy of the e-mail message at the handheld appliance;
sending updated status information regarding the processed e-mail to the e-mail account associated with the host system;
updating the status information of the incoming e-mail message on the host system to reflect the change in status of the processed e-mail.

2. The method of claim 1, wherein forwarding a copy of the incoming e-mail message to a handheld appliance further comprises the steps of:
forwarding the copy of the incoming e-mail message to a mail server;
storing the copy of the incoming e-mail message on the mail server;
downloading the stored e-mail message to a handheld appliance in response to a user command from the handheld appliance.

3. The method of claim 2, wherein forwarding the copy of the incoming e-mail message to a mail server further comprises encrypting the message to be forwarded using a standard encryption scheme.

4. The method of claim 3, wherein the encryption scheme is triple DES encryption.

5. The method of claim 2, wherein the e-mail message to be forwarded contains address information of a sender of the e-mail message and wherein forwarding a copy of the incoming e-mail message further comprises repackaging the e-mail to be forwarded such that the address information of the sender is preserved.

6. The method of claim 2, wherein the mail server is a POP3 server.

7. The method of claim 2, wherein the mail server is an IMAP server.

8. The method of claim 2, wherein the mail server maintains status information regarding the forwarded e-mail and wherein sending updated status information regarding the processed e-mail to the e-mail account associated with the host system further comprises:
sending e-mail status information for the e-mail processed on the handheld appliance to the mail server;
updating the e-mail status information on the mail server;
forwarding the updated e-mail status information to the e-mail account associated with the host system.

9. The method of claim 8, wherein forwarding the updated e-mail status information to the e-mail account associated with the host system further comprises:
generating an e-mail status message containing message identification and updated status information at the mail server;
sending the e-mail status message to the host system; and
updating the e-mail status information of the incoming e-mail message on the host system in accordance with the updated status information contained in the e-mail status message.

10. The method of claim 1, wherein the handheld appliance maintains status information regarding the forwarded e-mails, and wherein sending updated status information regarding the processed e-mail to the e-mail account further comprises:
sending e-mail status information for the e-mail processed on the handheld appliance to the host system.

11. The method of claim 1, wherein processing the forwarded e-mail message comprises one or more of reading, deleting, replying to, forwarding, or printing the forwarded e-mail message.

12. The method of claim 1, wherein the handheld appliance comprises one or more wireless devices selected from a group consisting of: a portable computer; a cellular phone; a personal digital assistant; an electronic organizer; or a two-way pager.

13. The method of claim 1, wherein the status information is an e-mail read status indicator.

14. The method of claim 1, wherein the status information is an e-mail delete status indicator.

15. The method of claim 1, wherein the status information is an e-mail reply status indicator.

16. The method of claim 1, wherein the status information is an e-mail forward status indicator.

17. A computer system for updating e-mail status information for forwarded e-mail messages, the system comprising:
a host system capable of sending and receiving e-mail messages;
a firewall separating the host system from a wide area network;
a handheld appliance;
a forwarding mail agent that forwards a copy of incoming e-mails from the host system across the firewall to the handheld appliance;
a remote access e-mail client located on the handheld appliance that processes e-mail messages;
wherein the remote access e-mail client forwards updated status information for e-mails processed on the handheld appliance to the host system.

18. The system of claim 17, wherein the handheld appliance comprises one or more wireless devices selected from a group consisting of: a portable computer; a cellular phone; a personal digital assistant; an electronic organizer; or a two-way pager.

19. The system of claim 17, wherein the remote access e-mail client manages multiple user e-mail accounts.

20. The system of claim 17, wherein the forwarding mail agent is located on the host system.

21. The system of claim 17, wherein the forwarding mail agent is located on a server connected to the host system by a local area network;

22. The system of claim 17, wherein the forwarding mail agent receives the updated status information from the handheld appliance and updates status information of the incoming e-mail on the host system.

23. The system of claim 17, wherein the updated status information is an e-mail read status indicator.

24. The system of claim 17, wherein the updated status information is an e-mail delete status indicator.

25. The system of claim 17, wherein the updated status information is an e-mail reply status indicator.

26. The system of claim 17, wherein the updated status information is an e-mail forward status indicator.

27. A computer system for updating e-mail status information for forwarded e-mail messages, the system comprising:
a host system capable of sending and receiving e-mail messages;
a firewall separating the host system from a wide area network;
a handheld appliance;
a proxy mail server;
a forwarding mail agent that forwards a copy of incoming e-mails from the host system across the firewall to an account on the proxy mail server;
a remote access e-mail client located on the handheld appliance that processes e-mail messages;
a proxy mail server component that, in response to a triggering mechanism, downloads the forwarded e-mail messages from the account on the proxy mail server component to the remote access e-mail client;
wherein updated status information for e-mails processed on the handheld appliance is forwarded to the host system.

28. The system of claim 27, wherein the handheld appliance comprises one or more wireless devices selected from a group consisting of: a portable computer; a cellular phone; a personal digital assistant; an electronic organizer; or a two-way pager.

29. The system of claim 27, wherein the remote access e-mail client manages multiple user e-mail accounts.

30. The system of claim 27, wherein the forwarding mail agent is located on the host system.

31. The system of claim 27, wherein the forwarding mail agent is located on a server connected to the host system by a local area network;

32. The system of claim 27, wherein the forwarding mail agent receives the updated status information from the handheld appliance and updates status information of the incoming e-mail on the host system.

33. The system of claim 27, wherein the proxy mail server is a POP3 server.

34. The system of claim 27, wherein the proxy mail server is an IMAP server.

35. The system of claim 27, wherein the updated status information is forwarded from the handheld appliance to the proxy mail server, and then forwarded to the host system.

36. The system of claim 35, wherein the proxy mail server component receives the updated status information, and generates an updated status e-mail that is forwarded to the host system.

37. The system of claim 27, wherein the triggering mechanism is a user command from the handheld appliance.

38. The system of claim 27, wherein the triggering mechanism is an automated mechanism on the host system.

39. The system of claim 27, wherein the triggering mechanism is a mechanism on the proxy server.

40. A method of remotely accessing an incoming e-mail message received at an e-mail account associated with a host system on a local area network separated from a wireless wide area network by a firewall, the method comprising:
receiving the incoming e-mail message at the e-mail account associated with the host system;
forwarding a copy of the incoming e-mail to a mail server located outside the firewall;
storing the incoming e-mail message at the mail server;
downloading the e-mail message from the mail server to a handheld appliance in response to a command from the handheld appliance.

41. The method of claim 40, wherein forwarding a copy of the incoming e-mail message to a mail server further comprises encrypting the message to be forwarded using a standard encryption scheme.

42. The method of claim 41, wherein the encryption scheme is triple DES encryption.

43. The method of claim 40, wherein the e-mail message to be forwarded contains address information of a sender of the e-mail message and wherein forwarding a copy of the incoming e-mail message further comprises repackaging the e-mail to be forwarded such that the address information of the sender is preserved.

44. The method of claim 40, wherein the mail server is a POP3 server.

45. The method of claim 40, wherein the mail server is an IMAP server.

46. The method of claim 40, wherein the handheld appliance comprises one or more wireless devices selected from a group consisting of: a portable computer; a cellular phone; a personal digital assistant; an electronic organizer; or a two-way pager.
